(19) United States
(12) Patent Application Publication
(10) Pub. No.: US 2025/0376389 A1
(43) Pub. Date: Dec. 11, 2025

(54) SORBENT CARBON MEDIA FOR CHLORAMINE REDUCTION AND METHOD OF MAKING SAME

(71) Applicant: Marmon Water (Singapore) PTE LTD, Singapore (SG)

(72) Inventors: Vijayanand Subramanian, Rachenahalli (IN); Mallikarjuna Shroff Rama, Bengaluru (IN); Mark Stouffer, Middletown, CT (US)

(21) Appl. No.: 18/793,467

(22) Filed: Aug. 2, 2024

(30) Foreign Application Priority Data
Jun. 10, 2024 (IN) 202421044856

(51) Int. Cl. C02F 1/28; B01J 20/20; B01J 21/18; B01J 31/18; B01J 35/30; B01J 37/02; B01J 37/04; B01J 37/08; C02F 1/72; C02F 101/12; C02F 101/16

(52) U.S. Cl. CPC C02F 1/288; B01J 20/20; B01J 21/18; B01J 31/181; B01J 35/394; B01J 37/0203; B01J 37/0207; B01J 37/0213; B01J 37/0236; B01J 37/04; B01J 37/08; C02F 1/725; B01J 2231/005; B01J 2531/16; B01J 2531/72; B01J 2531/842; C02F 1/283; C02F 2101/12; C02F 2101/16

(57) ABSTRACT

Methods of making catalytically active metal-triazine treated carbon particles, and the resultant catalytically activated metal-triazine sorbent carbon media. The particles are formed by soaking an activated carbonaceous product in an oxidizing acid solution and exposing the oxidized activated carbon to at least one metal-triazine complex in solution for a time sufficient to form metal-triazine impregnated carbon particles. The impregnated carbon particles are heated in a non-oxidizing atmosphere to render calcined metal-triazine impregnated carbon particles, which are cooled to form catalytically active metal-triazine treated carbon particles that remove chloramines from aqueous solution. The resultant catalytically activated metal-triazine treated carbon particles are formed into filter media and/or blocks for removing at least chloramines from aqueous solution.

### TECHNICAL FIELD

The present invention relates generally to treated filter media and, more particularly, to material compositions and methods of making the same for efficient removal of chloramines and chlorine from an aqueous stream.

### DESCRIPTION OF RELATED ART

Chloramines are a well-known group of disinfectants used in treating drinking water. They are formed by adding ammonia to water containing free-chlorine at the first stage of chlorination. During this reaction three different inorganic chloramines are formed: monochloramine (NH₂Cl), dichloramine (NHCl₂), and trichloramine (NCl₃).

While chloramine is a weaker disinfectant than chlorine, it is more favorable than chlorine due to it being less reactive. The decreased reactivity of chloramine results in it being less likely to react with organic compounds, and in turn, less likely to create harsh disinfection by-products (DBPs). For instance, chloramine is less likely to form trihalomethanes (THMs) and haloacetic acids (HAAs), both of which are formed as DBPs during chlorine disinfectant treatment of drinking water. THMs and HAAs are undesired carcinogenic by-products likely to cause damage and injury to organs, the reproductive system, and birth defects.

Even though chloramine is less reactive, it still results in other undesired DBPs. For instance, chloramine may result in DBPs (e.g., nitroamines, iodo-trihalomethanes and iodo-acids) which affect people with compromised immune systems. Chloramines can also cause lead leaching from lead pipes, problems for coffee/tea machines and ice machines, and affect the taste of soft-drink beverages made from drinking water. Chloramines have also been found to present undesirable odors and taste in drinking water. As such, chloramine removal from drinking water is imperative to avoid any undesired toxicity, odors, and taste.

However, the physical structure of chloramines leads to difficulty in their removal from aqueous solutions as they are small, stable molecules with no charge. It has been found that carbon filters do not adsorb chloramines but rather remove them through a catalytic process, breaking them down to harmless chlorides in the water. Effective and reliable chloramine reduction requires specially treated activated carbon.

A common practice to induce activated carbon infinity to chloramine reduction is to expose the activated carbon to nitrogen-containing compound at high temperatures ranging between 700 and 900° C. Under these conditions, graphitic layers of the carbon matrix become loose and basal plane of the activated carbon becomes susceptible to a reactive species. At this point the carbon matrix can easily be doped with specific catalytic species or create catalytic sites in the form of foreign elements or functional groups. Well known approaches include exposing the carbon to nitrogen-containing compounds, such as ammonia, urea or the like, at high temperatures to dope the carbon matrix with nitrogen.

For instance, in U.S. Pat. No. 6,699,393 issued to Baker, et al., titled “METHOD FOR REMOVAL OF CHLORAMINES FROM DRINKING WATER,” teaches removing chloramine from fluid streams by contacting the fluid stream with a catalytically active carbon that has been pyrolyzed in the presence of nitrogen-containing molecules, versus, steam activated carbon.

U.S. Pat. No. 10,953,386 issued to Pal, titled “FILTRATION MEDIA FOR REMOVING CHLORAMINE, CHLORINE, AND AMMONIA, AND METHOD OF MAKING THE SAME,” teaches treating activated carbon only with a nitrogen-rich compound, in particular, melamine. The nitrogen-rich compound alone, in an unaltered state, is used to treat the activated carbon.

U.S. Pat. No. 9,446,328 issued to Stouffer, titled “FILTRATION MEDIUM COMPRISING A METAL CONTAINING PARTICLE,” discloses use of a thermolysis product of a metal salt including chlorides, nitrogen containing oxy-anions, sulfur containing anions, phosphates and combinations thereof. The metal salt thermolysis products are provided on a substrate for chloramine reduction in aqueous solution.

U.S. Patent Publication No. 2022/0062862, titled “COPPER AND NITROGEN TREATED SORBENT AND METHOD FOR MAKING SAME” discloses copper and nitrogen doping of an activated carbon, followed by calcining the Cu—N doped precursor activated carbon to form a sorbent material. A precursor activated carbon is treated by contacting it with a single solution containing both the copper compounds and the nitrogen compounds, wherein the copper source comprises of CuSO4.5H2O, CuCO3(OH)2 and the nitrogen compounds include urea, CO(NH₂)₂, aqueous ammonium hydroxide, NH₄OH (nominally aq, 28 wt. %), or ammonium carbonate.

However, many of the known approaches for preparing catalytically active chloramine removal media have disadvantages and limitations, including the above discussed prior art. The present invention provides alternative compositions and methods of making catalytically active carbon for chlorine and chloramine reduction that demonstrate enhanced chloramine reduction capacity.

### SUMMARY OF THE INVENTION

Bearing in mind the problems and deficiencies of the prior art, it is therefore an object of the present invention to provide methods of fabricating treated water filtration media for enhanced reduction and/or removal of chloramines.

Another object of the present invention is to provide treated water filtration media, including water purification filtration blocks, having enhanced capabilities for reduction and/or removal of chloramines from water.

It is another object of the present invention to provide methods of reducing and/or removing chloramines from water using the various treated water filtration media of the invention.

Other objects of the invention are to provide methods of treating water filtration media, the resultant treated water filtration media, and methods of removing chloramines in a cost effective and efficient manner.

Still other objects and advantages of the invention will in part be obvious and will in part be apparent from the specification.

The above and other objects, which will be apparent to those skilled in the art, are achieved in the present invention which is directed to a method of making catalytically active metal-triazine treated carbon particles by providing an activated carbonaceous product and soaking it in an oxidizing acid solution to form oxidized activated carbon. The oxidized activated carbon is exposed to one or more metal-triazine complexes in solution to form metal-triazine impregnated carbon particles. The metal-triazine impregnated carbon particles are heated in a non-oxidizing atmosphere to render calcined metal-triazine impregnated carbon particles, which are cooled to form catalytically active metal-triazine treated carbon particles that remove at least chloramines from aqueous solution.

The method may further include draining and drying the oxidized activated carbon prior to exposing it one or more metal-triazine complexes in solution. In doing so, the oxidized activated carbon may be dried at a temperature ranging from about 80° C. to 120° C. until moisture content of the oxidized activated carbon is about or less than 20%.

In accordance with the invention, the activated carbonaceous product may be coconut-shell based activated carbon, coal-based activated carbon, wood-based activated carbon, and/or combinations thereof. The activated carbonaceous product may be granular or powdered form having a surface area ranging from about 400 m²/g to about 2500 m²/g. In the methods of the invention, the activated carbonaceous product may be soaked in an oxidizing acid solution including, but not limited to, sulfuric acid, phosphoric acid, nitric acid, hydrochloric acid, and/or combinations thereof. In one or more embodiments, the oxidizing acid solution may be a 5% to 15% v/v nitric acid in aqueous solution, whereby the activated carbonaceous product is soaked in the nitric acid aqueous solution in a ratio of 1:1 to 1:2 by volume for a duration of about 15 min to 4 hours.

The one or more metal-triazine complexes of the invention may be one or more transition metals mixed in solution with a triazine material. In one or more embodiments the one or more transition metals may be iron, manganese, copper, and/or combinations thereof. In certain embodiments the one or more transition metals may be iron salt provided in an amount sufficient to provide an iron content in an amount ranging from about 0.001% to 2.0% (based on a total weight of oxidized activated carbon to be treated) mixed with the triazine material in an amount ranging from about 0.1% to 30% (based on a total weight of oxidized activated carbon to be treated) to render an iron-triazine complex. In other embodiments the one or more transition metals may be manganese salt provided in an amount sufficient to provide a manganese content in an amountranging from about 0.005% to 2.0% (based on a total weight of oxidized activated carbon to be treated) mixed with the triazine material in an amount ranging from about 0.1% to 30% to render a manganese-triazine complex. In still other embodiments the one or more transition metals may be copper salt provided in an amount sufficient to provide a copper in an amount ranging from about 0.001% to 4.0% (based on a total weight of oxidized activated carbon to be treated) mixed with the triazine material in an amount ranging from about 0.1% to 30% to render a copper-triazine complex. It should be appreciated and understood that in all above embodiments the amounts are based on a total weight of oxidized activated carbon to be treated.

In the invention the one or more metal-triazine complexes may be about 0.001% to 2.0% iron content mixed with about 0.1% to 30% triazine, about 0.005% to 2.0% manganese content mixed with about 0.1% to 30% triazine, about 0.001% to 4.0% copper content mixed with about 0.1% to 30% triazine, and/or combinations thereof. All amounts are based on a total weight of oxidized activated carbon to be treated. The one or more metal-triazine may be iron-melamine complex, manganese-melamine complex, copper-melamine complex, and/or combinations thereof. In these embodiments, the one or more metal-triazine complexes may comprise iron salt provided in an amount sufficient to provide iron content in an amount of about 0.001% to 2.0% mixed with about 0.1% to 30% melamine, manganese salt provided in an amount sufficient to provide manganese content in an amount of about 0.005% to 2.0% mixed with about 0.1% to 30% melamine, copper salt provided in an amount sufficient to provide copper content in an amount of about 0.001% to 4.0% mixed with about 0.1% to 30% melamine, and/or combinations thereof. All above amount percentages of each the iron, manganese, copper and/or melamine are based on a total weight of oxidized activated carbon to be treated.

In accordance with the invention, one or more metal-triazine complexes may comprise metal content to triazine in the solution at a ratio greater than 1:3. The oxidized activated carbon may be exposed to the one or more metal-triazine complexes in solution for at least 10 minutes, and up to about 2 to 5 hours. The methods of the invention may further include drying the metal-triazine impregnated carbon particles, prior to forming the calcined metal-triazine impregnated carbon particles. This drying step may be performed by heating the impregnated carbon particles to a temperature ranging from about 80°° C. to 180° C. until the moisture level of the metal-triazine impregnated carbon particles reaches at least a moisture content of less than 20%. The step of forming calcined metal-triazine impregnated carbon particles may be accomplished by heating the metal-triazine impregnated carbon particles while still wet to a temperature between about 350° C. to 1100° C. under the non-oxidative environment. The one or more metal-triazine complexes in solution may be directly sprayed onto or mixed with the oxidized activated carbon while still in a wet state.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1 to 3 illustrate graphed results depicting the enhanced monochloramine (MCA) removal capacity of resultant catalytically activated carbon media doped with various metal-triazine complexes, in accordance with embodiments of the invention, as compared to sorbent carbon media treated only with triazine. The monochloramine removal capacity measured in terms of mg/g (mg of chloramine removed per gram of carbon sample added) at 20 minutes of contact time.

FIGS. 4 and 5 illustrate other graphed results of the invention depicting enhanced monochloramine (MCA) removal capacity of resultant catalytically activated carbon media doped with two or more metal-triazine complexes, in accordance with the invention, as compared to sorbent carbon media treated only with triazine.

FIG. 6 illustrates still further graphed results of the invention depicting enhanced monochloramine (MCA) removal capacity of resultant catalytically activated carbon media doped with a plurality of different metal-triazine complexes, in accordance with the invention, as compared to sorbent carbon media treated only with triazine.

### MODE(S) FOR CARRYING OUT INVENTION

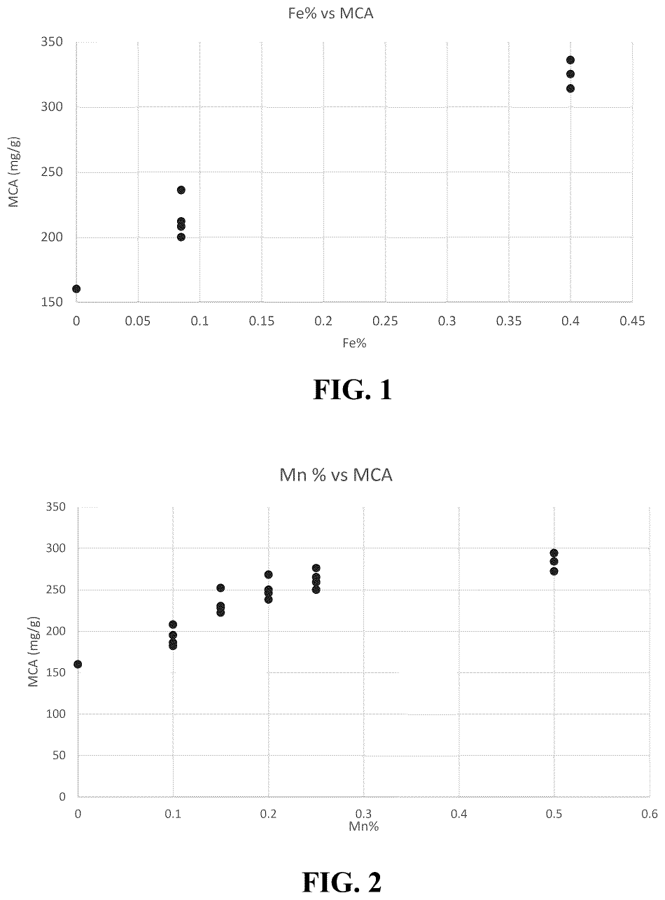

In describing the preferred embodiment of the present invention, reference will be made herein to FIGS. 1-6 of the drawings in which like numerals refer to like features of the invention.

The embodiments of the present invention can comprise, consist of, and consist essentially of the features and/or steps described herein, as well as any of the additional or optional ingredients, components, steps, or limitations described herein or would otherwise be appreciated by one of skills in the art. It is to be understood that all concentrations disclosed herein are by weight percent (wt. %.) based on a total weight of the composition or formulations being made, unless otherwise indicated.

The present invention is directed to methods of making highly active catalytic carbon with enhanced chloramine reduction capacity for enhanced removal of chloramines, as well as chlorine, from an aqueous stream, particularly, drinking water. In accordance with one or more embodiments, the invention is directed to material compositions, methods of making the material compositions, and methods of fabricating the formed material compositions into treated activated carbon-based filter media and/or blocks, along with the resultant media/blocks themselves having enhanced chloramine reduction. In particular, methods of the invention are directed to doping activated carbon with metal-triazine complexes followed by calcination resulting in a metal-triazine complex treated catalytically activated carbon material having enhanced capacity to reduce chloramines from water to provide clean drinking water.

The catalytically active metal-triazine treated carbon material of the invention, when made into a media or a solid activated carbon block, provides significantly improved chloramine/chlorine removal efficiency as compared to existing catalytic carbon materials known in the prior art. For instance, the present catalytically active metal-triazine treated carbon material provides enhanced chloramine/chlorine removal as compared to activated carbon treated with triazine (e.g., melamine) alone. It has been found that the present methods of forming the metal-triazine complex carbon material advantageously lower the carbon footprint, are less expensive as compared to known techniques since the invention uses less expensive, environmentally friendly precursor compounds, and provide improved sustainability.

In accordance with one or more embodiments, the invention is directed to methods of making a catalytically active metal-triazine complex treated carbon material using an activated carbonaceous product as a starting material. The starting material may be an activated carbon material selected from various sources, including, but not limited to, coconut-shell based activated carbon, coal-based activated carbon, wood-based activated carbon, and combinations thereof. The activated carbon may further be classified into granular activated carbon, powder activated carbon, and extruded activated carbon, all of which are based on the mean particle dimensions and shapes. Granular activated carbon is irregular shaped particles having sizes ranging from 0.2 to 5 mm. Powder activated carbon is pulverized carbon generally having a particle size ranging from less than 0.25 mm. Extruded activated carbon is cylindrical pellets with diameters ranging from 1 mm to 5 mm. Surface area and porosity plays a major role in the process of adsorption by the activated carbon. Generally, the higher the internal surface area and pore volume, the higher the effectiveness of the carbon.

Coconut shell based activated carbon has a greater number of micropores (pore size less than 2 nm), as compared to coal (more mesopores and less micropores) and wood (more mesopores and macropores) activated carbon. In accordance with one or more preferred embodiments of the invention, the activated carbon may include a coconut-based carbon or a coal-based carbon or wood-based carbon, either in granular (GAC) or powdered form (PAC). It is preferred that the carbon-based support is porous having high surface area ranging from about 400 m²/g to about 2500 m²/g, preferably from about 800 m²/g to about 1300 m²/g, based on the Brunauer Emmet Teller (BET) method for nitrogen adsorption. In one or more embodiments the carbon-based support may have a porous surface area of at least 1000 m²/g based on BET method.

In one or more preferred embodiments, once the desired activated carbon (i.e., sorbent feedstock) is selected, it is treated with an oxidizing agent (diluted oxidizing acid) followed by drying to obtain oxidized activated carbon. In accordance with the invention, a strong oxidizing acid agent may be used including, but not limited to, sulfuric acid, phosphoric acid, nitric acid, hydrochloric acid, combinations thereof, and the like. In one or more embodiments, the activated carbon is oxidized using nitric acid which is a strong oxidizing agent having a low boiling point. For instance, the activated carbon may be oxidized in a nitric acid aqueous slurry by soaking the carbon in a nitric acid solution in a ratio of 1:1 to 1:2 by volume where in the nitric acid solution is obtained by mixing 5% to 15% v/v of concentrated nitric acid in water, preferably 10% v/v of concentrated nitric acid in water, at room temperature (does not need elevated temperature) for at least 5 minutes, preferably at least 30 minutes, and more preferably for a duration of at least 2 to 4 hours. In one or more preferred embodiments the carbon is soaked or mixed in the nitric acid solution for approximately 3 hours.

After the oxidation soak is complete, the aqueous solution is drained to obtain the oxidized activated carbon material, which is then dried at temperatures that enable removal of a majority of the moisture, if not all. In one or more embodiments, the oxidized activated carbon slurry is dried in a tunnel drier/fluidized bed reactor at a low temperature, preferably greater than 50° C., more preferably, between approximately 80°° C. to 120° C. For instance, in one or more embodiments the slurry may be dried at approximately 80° C. The oxidized activated carbon slurry is dried at these low temperatures until the final moisture content of the acid treated carbon (i.e., the oxidized activated carbon) is less than approximately 20%, preferably less than 10%, and most preferably less than 5%. The nitric acid is easily removed and does not require an elevated temperature in the drying process.

In accordance with the invention, the oxidized activated carbon is then doped with metal-triazine complexes. In one or more embodiments, the metals may be metal salts. Suitable metals for use in the invention include, but are not limited to, transition metals including iron (Fe), manganese (Mn), copper (Cu), and combinations thereof. The metal-triazine complexes thereof are obtained by mixing corresponding metal salts with triazine in aqueous slurry. The molar ratio of metal content to triazine is chosen at greater than 1:3. The metal salts thereof are particularly preferred and may include, for instance, iron chloride, manganese chloride, copper sulfate, and combinations thereof. While not meant to be limiting, metal salts suitable for use in the invention may include, for instance, metal chlorides, metal nitrates, metal bromides, metal acetates, metal sulfates, and the like. The metals may be selected from iron, manganese and copper, and be in different oxidation states, such as, for example: iron may be Fe(II) state (or Fe2+) or Fe(III) state (or Fe3+); Copper may be in Cu(I) state (or Cu¹⁺) or Cu(II) state (or Cu²⁺).

The triazine component of the invention is preferably a nitrogen-rich triazine. Triazines exist in three isomeric forms, with 1,3,5-triazines being common. A well-known triazine is melamine (1,3,5-Triazine-2,4,6-triamine, C3H6N6, molar mass 126.12 g/mol) which contains 67% nitrogen by total mass. In one or more embodiments, the preferred nitrogen-rich triazine is melamine and/or equivalent melamine substitutes. While not meant to be limiting, it should be appreciated various nitrogen-rich triazines are suitable for use in the invention including 1,2,3-triazine 1,2,4-triazine, 1,3,5-triazine, melamine, substituted melamines, cyanuric acid, cyanuric chloride, trichloro melamine, ammelide, ammeline, and the like.

In doping the dried, or nearly dried, oxidized activated carbon with metal-triazine complexes, one or more transition metal salts is dissolved in water along with a nitrogen-rich triazine material to form a metal-triazine complex suspension. In one or more embodiments the transition metal salts may comprise iron salt, manganese salt, copper salt, and combinations thereof. The metal-triazine complex suspension may be prepared by dissolving in solution (i.e., water) one or more of iron salt provided in an amount sufficient to provide iron content in an amount of about 0.001% to 2.0%, preferably about 0.02% to 1.5%, most preferably about 0.02% to 0.8% of iron content; manganese salt provided in an amount sufficient to provide manganese content in an amount of about 0.005% to 2.0%, preferably about 0.02% to 1.5%, most preferably about 0.02% to 0.8% of manganese content; and/or copper salt provided in an amount sufficient to provide copper content in an amount of about 0.001% to 4.0%, preferably about 0.02% to 2.0%, most preferably about 0.02% to 0.8% of copper content, all based on a total weight of oxidized activated carbon to be treated (i.e., doped). It should be appreciated that the amount of metal salt provided is dependent upon the above metal content amount ranges needed for treating/doping oxidized activated carbon based on a total weight thereof. In addition, the nitrogen-rich triazine material is added to the solution in an amount ranging from about 0.1% to 30%, preferably 5% to 30%, based on the total weight of oxidized activated carbon being doped. To ensure all metal salts are dissolved and complexed with the triazine material, upper ranges or larger amounts of triazine material may be added to the solution.

The one or more transition metal salts and triazine material are thoroughly mixed in solution until the metal salt(s) are fully dissolved and complexed with triazine forming metal-triazine complexes. In those embodiments where the transition metal salts are iron salt, manganese salt, and/or copper salt, the metal-triazine complexes formed include iron-triazine complex, manganese-triazine complex, and/or copper-triazine complex. In accordance with the various embodiments, the metal-triazine complex suspension may be formed with only iron-triazine complex, only manganese-triazine complex, only copper-triazine complex, or any combination of the iron-triazine, manganese-triazine, and copper-triazine complexes. It should be appreciated that in those embodiments including two or more transition metal salts combined to render the metal-triazine complex suspension, the metal salts may be added to a single solution to make the metal-triazine complex suspension, or alternatively, added to separate solutions to render separate iron-triazine, manganese-triazine, and/or copper-triazine solutions that are subsequently combined together to render to resultant metal-triazine complex suspension of the invention.

In one or more embodiments, an iron salt comprising iron chloride, manganese salt comprising manganese chloride, and/or copper salt comprising copper sulfate may be added to solution along with the triazine material. In certain embodiments the triazine may be melamine to render a metal-triazine complex suspension containing iron-melamine, manganese-melamine, and/or copper-melamine complexes therein. In one or more preferred embodiments, the iron salt may be provided in an amount sufficient to provide iron content in an amount less than about 0.085%, the manganese salt provided in an amount sufficient to provide manganese content in an amount greater than about 0.005%, and/or the copper salt provided in an amount sufficient to provide copper content in an amount less than about 0.085%, along with about 5% to 30% triazine material (all based on total weight of oxidized activated carbon) may be added to solution and mixed therein for a duration that allows all of the metal salts to complex with the triazine to form metal-triazine complexes. For instance, the iron salt may provide an iron content in an amount less than about 850 milligram per kilogram carbon (<850 mg/kg carbon or 0.085% total carbon to be doped), the manganese salt may provide manganese content in an amount greater than about 50 milligram per kilogram carbon (>50 mg/kg or 0.005%), and/or the copper salt may provide copper content in an amount less than about 850 milligram per kilogram carbon (<850 mg/kg or 0.085%), triazine in an amount greater than 50 milligram per kilogram carbon (>50 mg/kg or 0.005%).

Once the present metal-triazine complex suspension is formed, the oxidized activated carbon (i.e., acid-treated carbon) is treated or doped with the metal-triazine complex suspension. In one or more embodiments, the oxidized activated carbon and the aqueous metal-triazine complex suspension may be loaded into a ribbon blender. While homogeneously mixing, the oxidized activated carbon are mixed and soaked in the suspension for a duration of at least 10 minutes, preferably for a duration of approximately 2 to 5 hours, more preferably, for about 3 to 4 hours. During this mixing and soaking process, the iron-melamine, manganese-melamine, and/or copper-melamine complexes are impregnated onto and/or into the oxidized activated carbon to render metal-triazine impregnated carbon material of the invention. While the invention is described in connection with soaking and mixing the oxidized activated carbon in the metal-triazine complex suspension, it should be appreciated that other techniques for impregnating material into a carbonaceous product may be used in the invention (e.g. spray the metal-triazine complex suspension onto the oxidized carbon feedstock slurry).

Once doping is complete, the slurry containing metal-triazine impregnated carbon may be drained, if necessary, and then the aqueous phase of the slurry is separated from the solid carbon component by filtration. For instance, excess water may be removed by centrifuge. The separated metal-triazine impregnated carbon material is then dried in an oven or tunnel drier at temperatures greater than 50° C., preferably temperatures from about 80° C. to 180° C. The impregnated carbon material is dried until the moisture level of the metal-triazine treated/doped carbon material reaches a moisture content of less than 20%, more preferably to a moisture content less than 10% moisture.

While the impregnated carbon material is still wet (i.e., having moisture content less than 20%, preferably less than 10%), the wet metal-triazine impregnated carbon material undergoes calcination by heating the material at a temperature between about 350° C. to 1100° C., preferably between about 700° C. to 900° C., under a non-oxidative environment. In the calcination process the atmosphere may contain volatile and decomposing gases as a result of heating of the impregnated feedstock, such that the environment may not be inert. The calcined material is then cooled under an oxygen-free, or otherwise inert, atmosphere to ambient temperature to provide the resultant catalytically activated metal-triazine carbon material/particles having enhanced capacity to reduce and/or remove at chloramines and chlorine from water to provide clean drinking water. In particular, the resultant high performance catalytically active carbon material/particles efficiently remove chloramine from drinking water in the form of a solid carbon block or granular carbon media. Chlorine may also be removed via this carbon-based media.

In accordance with various embodiments of the invention, each of the above steps may be performed in sequential order, or optionally certain steps may be performed simultaneously. For instance, the steps of forming the metal-triazine complex suspension and doping the oxidized activated carbon may be performed in a single step. It should also be appreciated that while the invention is described in relation to range amounts of transition metals used to form the metal-triazine complex suspension, in one or more embodiments it is preferred that lesser amounts of the transition metal salt be used (i.e., measures at the low end of the material amount ranges) to form the transition metal-triazine complexes. Lower concentrations or amounts will reduce any undesired leaching of metals from use of the resultant catalytically activated metal-triazine carbon material/particles. So long as the chosen lower amount of transition metal used is sufficient to form enough metal-triazine complex in suspension for forming the final catalytically activated metal-triazine carbon material that actively removes chloramine, then such chosen lower amount is encompassed by and suitable for use in the invention. Referring to the below Table 1, chosen lower amount(s) (concentrations) may fall at the lower ends of the transition metal content ranges set forth below. Other embodiments of the invention may implement upper limit (larger) amounts of the metal(s), so long as such amounts do not result in metal leaching from the final product that pass the acceptable leaching limits as per NSF/ANSI 42-2022 protocol for the various transitions metals, as defined below in Table 1.

In yet another embodiment of the invention, one or more steps may be skipped during the process. For instance, draining and drying of oxidized carbon after treating the activated carbon with dilute acid to produce oxidized carbon can be skipped and directly aqueous suspension of metal-triazine complex is sprayed or mixed when it still in wet condition. In the next step, the metal-triazine impregnated carbon is further dried, calcined in a non-oxidative environment and cooled down to ambient temperature to obtain catalytically active metal-triazine treated carbon.

Table 1: Suitable ranges of metal content for use in embodiments of the invention.

| | | | | ACCEPTABLE LEACHING | |
|---|---|---|---|---|---|
| | | | | LIMITS as per NSF/ANSI 42 - | |
| | Range | Preferred | Most Preferred | 2022 protocol. | |
| Fe | 0.001% to 2.0% | 0.02% to 1.5% | 0.02% to 0.8% | 0.300 | mg/L |
| Mn | 0.005% to 2.0% | 0.02% to 1.5% | 0.02% to 0.8% | 0.120 | mg/L |
| Cu | 0.001% to 4.0% | 0.02% to 2.0% | 0.02% to 0.8% | 1300 | mg/L |

Below are exemplary embodiments for making a catalytically activated metal-triazine sorbent carbon material, particles or media of the invention, along with corresponding test data set forth Tables. In these exemplary embodiments, activated carbon was treated with an oxidizing agent (diluted acid) followed by drying to obtain oxidized activated carbon. The oxidizing acid may be a diluted acid, such as, sulfuric acid, phosphoric acid, nitric acid, hydrochloric acid or in combinations thereof diluted in aqueous medium. The activated carbon was soaked and mixed in the diluted acid aqueous medium for at least 5 minutes, preferably for at least about 30 minutes, and more preferably for at least 2 to 4 hours to form a slurry containing oxidized activated carbon. After soaking, the aqueous slurry is drained to separate the solution from the oxidized activated carbon. The oxidized activated carbon is then dried a temperature sufficient to remove the moisture preferably at a temperature greater than 50° C., more preferably between 80° C. to 120° C., for a duration until the oxidized activated carbon has a moisture content less than 20%, preferably less than 5%.

Referring to Tables 2 to 7 below, the oxidized activated carbon of the invention was then doped using different transition metal-triazine complexes, wherein each metal-triazine complex is obtained by reaction of a metal content with triazine in a molar ratio greater than 1:3. Particularly, the metal salts are selected from iron salt, manganese salt, copper salt, and combinations thereof, in the presence of a sufficient amount of a nitrogen-rich triazine material, preferably melamine. In Tables 2-6 different amounts/concentrations of metal salts were mixed with a fixed amount of triazine material. In particular, in various examples or samples, different amounts of one or more iron salt, manganese salt, and/or copper salt were added to solution in combination with melamine, whereby in each solution of each example a fixed amount of 14.2% melamine was added, based on the total weight of oxidized carbon being (or to be) doped. In table 7 below, different amounts of metal contents and different amounts melamine were added to solution for doping the oxidized activated carbon.

After the various metal-triazine complex suspensions were formed in the different test examples described in Tables 2 to 7, each batch of oxidized activated carbon were soaked and mixed in their respective suspensions for about 3 hours to dope and impregnate the carbon with the metal-melamine complexes formed in solution. Afterwards, the supernatants of the various suspensions were drained, followed by drying the metal-melamine impregnated carbon material/particles as described above. Calcination steps were then performed on each test sample at a temperature of at least about 350° C. (preferably between 700 to 1100° C.) under a non-oxidative environment for a duration of at least 10 min, preferably for a duration of at least 30 min to 2 hours, more preferable for duration of at least 3 to 8 hours, followed by immediate cooling the calcined material to render catalytically active metal-melamine treated carbon media. The various catalytically activated carbon materials rendered from the test samples were then used to filter drinking water and measured monochloramine (MCA) removal capacity data was obtained, as shown in Tables 2 to 7.

Table 2: Test samples 1 to 8 of Table 2 were prepared using different amounts iron salt (iron chloride) wherein concentrations are measured as iron content in percentage, based on the total weight of carbon to be doped. To the solution containing the iron salt, 14.2% melamine (based on weight of oxidized carbon) was added thereto. The oxidized activated carbon was mixed and soaked therein, drained, dried, and calcinated to render different catalytically active iron-melamine carbon samples, which were ultimately tested for monochloramine/chloramine removal capacity as measured in mg/g, whereby the chloramine removal amount was calculated by measuring remaining amount of chloramine in water containing a known concentration of chloramine that is in contact with 1 g of sorbent material at 20 min. As compared to oxidized activated carbon doped only with melamine (i.e., a triazine component) as shown in exemplary test sample 1, test samples 2 to 8 which include both a transition metal salt and melamine (i.e., a triazine component) exhibited enhanced removal of MCA, even when using as low as 0.085% iron content As shown in FIG. 1, the comparative test results of samples 1 to 8 are graphed and show that as the amount of transition metal content is increased, with a fixed amount of melamine at 14.2%, MCA removal continues to improve (samples 2 to 8). This graphed comparative data also shows that results of the invention provide improved MCA removal, as compared to sorbent media treated only with melamine (sample 1).

| Sample No: | 1 | 2 | 3 | 4 | 5 | 6 | 7 | 8 |
|---|---|---|---|---|---|---|---|---|
| Fe (%) | 0 | 0.085 | 0.085 | 0.085 | 0.085 | 0.4 | 0.4 | 0.4 |
| Melamine (%) | 14.2 | 14.2 | 14.2 | 14.2 | 14.2 | 14.2 | 14.2 | 14.2 |
| MCA (mg/g) | 160 | 200 | 208 | 212 | 236 | 314 | 325 | 336 |

Table 3: Similar to that of Table 2 above, Test samples 1 to 20 of Table 3 below demonstrate that use of a transition metal salt in combination with triazine to render metal-triazine complexes for impregnating into oxidized activated carbon exhibits enhanced removal of MCA, as compared to samples doped only with triazine (melamine) as shown in test sample 1. In samples 1 to 20 of Table 3, different amounts of manganese salt (manganese chloride) or percent concentrations measured as manganese content were used in combination with fixed melamine at 14.2%, based on weight of carbon being doped. These results also show that MCA removal continues to improve as the amount of transition metal salt is increased (i.e. as the amount of metal content is increased), while maintaining a fixed amount of melamine. FIG. 2 depicts the graphed results of the invention (samples 2 to 20), as compared to the comparative test sample 1 treated only with melamine. As shown, the resultant catalytic active carbon media of the invention doped with a manganese-melamine complex provide improved MCA removal as compared to sample 1.

| Sample No: | 1 | 2 | 3 | 4 | 5 | 6 | 7 | 8 | 9 | 10 | 11 |
|---|---|---|---|---|---|---|---|---|---|---|---|
| Mn (%) | 0 | 0.1 | 0.1 | 0.1 | 0.1 | 0.15 | 0.15 | 0.15 | 0.15 | 0.2 | 0.2 |
| Melamine (%) | 14.2 | 14.2 | 14.2 | 14.2 | 14.2 | 14.2 | 14.2 | 14.2 | 14.2 | 14.2 | 14.2 |
| MCA (mg/g) | 160 | 182 | 186 | 195 | 208 | 222 | 228 | 230 | 252 | 238 | 246 |

| Sample No: | 12 | 13 | 14 | 15 | 16 | 17 | 18 | 19 | 20 |
|---|---|---|---|---|---|---|---|---|---|
| Mn (%) | 0.2 | 0.2 | 0.25 | 0.25 | 0.25 | 0.25 | 0.5 | 0.5 | 0.5 |
| Melamine (%) | 14.2 | 14.2 | 14.2 | 14.2 | 14.2 | 14.2 | 14.2 | 14.2 | 14.2 |
| MCA (mg/g) | 250 | 268 | 250 | 259 | 265 | 276 | 272 | 284 | 294 |

Table 4: Test samples 1 to 13 of Table 4 below also demonstrate that enhanced chloramine removal capacity when doping with copper salt (copper sulfate), or percent concentrations measured as copper content, and triazine (melamine), as compared to doping with triazine (melamine) along (test sample 1 of Table 4). Low amounts of transition metal copper salts in combination with triazine have been found to be an effect approach of enhancing MCA removal while reducing chances of metal leaching found in approaches using high levels of metals for MCA removal. FIG. 3 depicts graphed results of the present catalytically active carbon media doped with a copper-melamine complex (samples 2 to 13) providing enhanced MCA removal, as compared to comparative test data treated only with melamine (sample 1).

| Sample No: | 1 | 2 | 3 | 4 | 5 | 6 | 7 | 8 | 9 | 10 | 11 | 12 | 13 |
|---|---|---|---|---|---|---|---|---|---|---|---|---|---|
| Cu (%) | 0 | 0.1 | 0.1 | 0.1 | 0.17 | 0.17 | 0.17 | 0.23 | 0.23 | 0.23 | 0.29 | 0.29 | 0.29 |
| Melamine(%) | 14.2 | 14.2 | 14.2 | 14.2 | 14.2 | 14.2 | 14.2 | 14.2 | 14.2 | 14.2 | 14.2 | 14.2 | 14.2 |
| MCA (mg/g) | 160 | 186 | 172 | 180 | 208 | 220 | 226 | 220 | 224 | 238 | 239 | 240 | 245 |

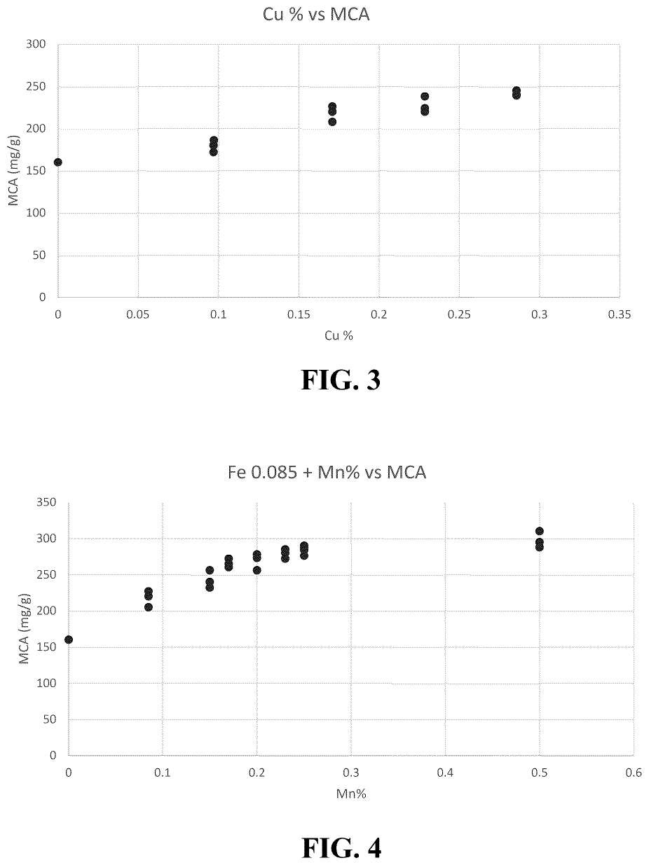

Table 5: Test samples 1 to 22 of Table 5 below implement a combination of metal salts or combination of percent concentrations measured as metal content in combination with triazine. In these test samples, the metal-triazine complex suspensions were formed using a combination of iron salt (iron chloride) and manganese salt (manganese chloride) in combination with melamine. Both the iron content and melamine were used at fixed amounts/concentrations, while amounts of manganese content were varied. The resultant catalytically activated metal-melamine sorbent carbon media obtained from samples 1 to 22 continued to show that a triazine component in combination with low amounts of one or more transition metals enhances MCA removal in drinking water. The results also show that use of small amounts of manganese in combination with iron enhances MCA removal, as compared to use of iron alone (see Table 2). The use of manganese in combination with iron also enables small amounts of iron to be used while still obtaining sufficient MCA removal, thereby reducing amounts of any iron leeching into the water being filtered. FIG. 4 depicts graphed test data of resultant catalytically activated carbon media doped with a combination of an iron-melamine complex and manganese-melamine complex (samples 2 to 22) providing enhanced MCA removal, as compared to comparative test data treated only with melamine (sample 1).

| Sample No: | 1 | 2 | 3 | 4 | 5 | 6 | 7 | 8 | 9 | 10 | 11 |
|---|---|---|---|---|---|---|---|---|---|---|---|
| Fe (%) | 0 | 0.085 | 0.085 | 0.085 | 0.085 | 0.085 | 0.085 | 0.085 | 0.085 | 0.085 | 0.085 |
| Mn (%) | 0 | 0.085 | 0.085 | 0.085 | 0.15 | 0.15 | 0.15 | 0.17 | 0.17 | 0.17 | 0.2 |
| Melamine(%) | 14.2 | 14.2 | 14.2 | 14.2 | 14.2 | 14.2 | 14.2 | 14.2 | 14.2 | 14.2 | 14.2 |
| MCA (mg/g) | 160 | 220 | 205 | 227 | 232 | 240 | 256 | 260 | 265 | 272 | 256 |

| Sample No: | 12 | 13 | 14 | 15 | 16 | 17 | 18 | 19 | 20 | 21 | 22 |
|---|---|---|---|---|---|---|---|---|---|---|---|
| Fe (%) | 0.085 | 0.085 | 0.085 | 0.085 | 0.085 | 0.085 | 0.085 | 0.085 | 0.085 | 0.085 | 0.085 |
| Mn (%) | 0.2 | 0.2 | 0.23 | 0.23 | 0.23 | 0.25 | 0.25 | 0.25 | 0.5 | 0.5 | 0.5 |
| Melamine(%) | 14.2 | 14.2 | 14.2 | 14.2 | 14.2 | 14.2 | 14.2 | 14.2 | 14.2 | 14.2 | 14.2 |
| MCA (mg/g) | 273 | 278 | 272 | 280 | 285 | 276 | 284 | 290 | 288 | 295 | 310 |

Table 6: Test samples 1 to 7 of Table 6 below included a transition metal combination of iron content (derived from iron chloride) and copper content (derived from copper sulfate) along with triazine (melamine). Both the iron content and melamine were used at fixed amounts/concentrations, while amounts of copper varied. The resultant catalytically activated metal-melamine sorbent carbon media obtained from samples 1 to 7 show that a triazine component in combination with low amounts of one or more transition metals enhances MCA removal in drinking water. FIG. 5 depicts graphed test data of resultant catalytically activated carbon media doped with a combination of an iron-melamine complex and copper-melamine complex (samples 2 to 7) providing enhanced MCA removal, as compared to comparative test data treated only with melamine (sample 1).

| Sample No: | 1 | 2 | 3 | 4 | 5 | 6 | 7 |
|---|---|---|---|---|---|---|---|
| Fe (%) | 0 | 0.085 | 0.085 | 0.085 | 0.085 | 0.085 | 0.085 |
| Cu (%) | 0 | 0.085 | 0.085 | 0.085 | 0.251 | 0.251 | 0.251 |
| Melamine(%) | 14.2 | 14.2 | 14.2 | 14.2 | 14.2 | 14.2 | 14.2 |
| MCA (mg/g) | 160 | 238 | 242 | 253 | 260 | 272 | 286 |

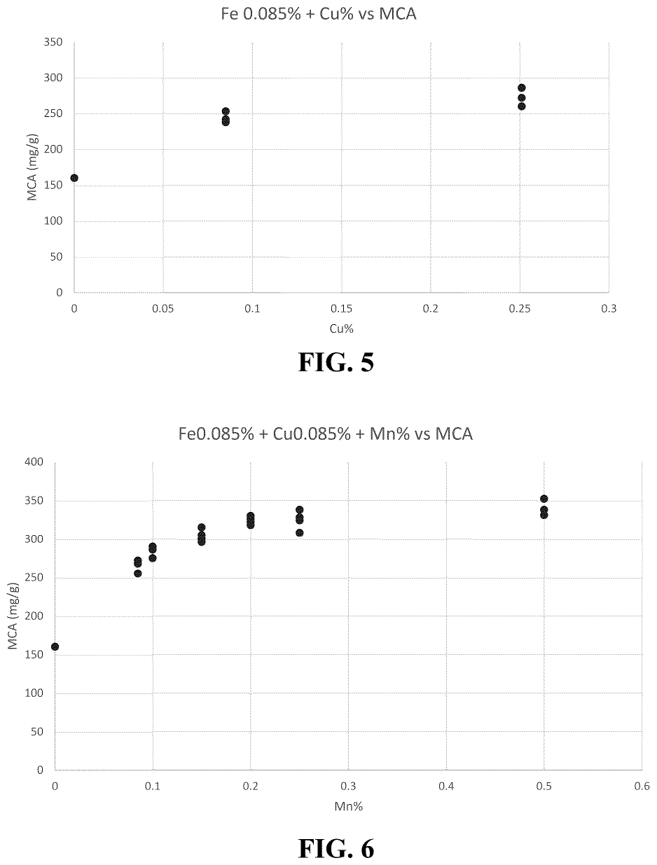

Table 7: Test samples 1 to 11 of Table 7 below included a combination of three metal-triazine complexes. The metal-triazine complex suspensions were formed using a combination of iron salt (iron chloride), manganese salt (manganese chloride) and copper salt (copper sulfate), all in combination with triazine (melamine). In these samples, the iron content, copper content, and melamine were used at fixed amounts/concentrations, while amounts of manganese were varied. With the presence of three different metal salts in combination with triazine to form different metal-triazine complexes within a suspension that is used to dope activated carbon, the resultant catalytically activated metal-melamine sorbent carbon media obtained from these samples also showed that a triazine component in combination with low amounts of a plurality of transition metals enhances MCA removal in drinking water. As shown in Table 7, the beneficial results of using small amounts of manganese in combination with iron and copper, both at low amounts, enhances MCA removal. By including manganese in combination with iron and/or copper, the manganese allows smaller amounts of iron and copper to be used while still resulting in sufficient MCA removal. The use of small amounts of manganese, iron and copper all reduce the undesired leaching thereof into water being filtered. FIG. 6 depicts graphed test results catalytically activated carbon media doped with a combination of an iron-melamine complex, manganese-melamine complex, and copper-melamine complex (samples 2 to 11) providing enhanced MCA removal, as compared to comparative test data treated only with melamine (sample 1).

| Sample No: | 1 | 2 | 3 | 4 | 5 | 6 | 7 | 8 | 9 | 10 | 11 |
|---|---|---|---|---|---|---|---|---|---|---|---|
| Fe (%) | 0 | 0.085 | 0.085 | 0.085 | 0.085 | 0.085 | 0.085 | 0.085 | 0.085 | 0.085 | 0.085 |
| Mn (%) | 0 | 0.085 | 0.085 | 0.085 | 0.1 | 0.1 | 0.1 | 0.15 | 0.15 | 0.15 | 0.15 |
| Cu (%) | 0 | 0.085 | 0.085 | 0.085 | 0.085 | 0.085 | 0.085 | 0.085 | 0.085 | 0.085 | 0.085 |
| Melamine(%) | 14.2 | 14.2 | 14.2 | 14.2 | 14.2 | 14.2 | 14.2 | 14.2 | 14.2 | 14.2 | 14.2 |
| MCA (mg/g) | 160 | 255 | 268 | 272 | 275 | 286 | 290 | 296 | 300 | 305 | 315 |

| Sample No: | 12 | 13 | 14 | 15 | 16 | 17 | 18 | 19 | 20 | 21 | 22 |
|---|---|---|---|---|---|---|---|---|---|---|---|
| Fe (%) | 0.085 | 0.085 | 0.085 | 0.085 | 0.085 | 0.085 | 0.085 | 0.085 | 0.085 | 0.085 | 0.085 |
| Mn (%) | 0.2 | 0.2 | 0.2 | 0.2 | 0.25 | 0.25 | 0.25 | 0.25 | 0.5 | 0.5 | 0.5 |
| Cu (%) | 0.085 | 0.085 | 0.085 | 0.085 | 0.085 | 0.085 | 0.085 | 0.085 | 0.085 | 0.085 | 0.085 |
| Melamine(%) | 14.2 | 14.2 | 14.2 | 14.2 | 14.2 | 14.2 | 14.2 | 14.2 | 14.2 | 14.2 | 14.2 |
| MCA (mg/g) | 318 | 322 | 326 | 330 | 308 | 324 | 328 | 338 | 331 | 338 | 352 |

Table 8: In Table 8 below, amounts of iron, manganese, copper, and triazine (melamine) were varied across test samples 1 to 8. The results show that small increments in metal-melamine complex loading leads to significant increase in the MCA removal, while higher increments in melamine loading are required to get even small enhancements in MCA removal (see, e.g., test samples 5 to 8). Regardless, the results continue to show that the resultant catalytically activated metal-melamine sorbent carbon media obtained from the samples in Table 8 that low amounts of metal in combination with a triazine component enhance MCA removal in drinking water.

| Sample No: | 1 | 2 | 3 | 4 | 5 | 6 | 7 | 8 |
|---|---|---|---|---|---|---|---|---|
| Fe (%) | 0.4 | 0.4 | 0.085 | 0.085 | 0.085 | 0.085 | 0.085 | 0.085 |
| Mn (%) | 0 | 0 | 0.5 | 0.5 | 0.085 | 0.085 | 0.085 | 0.085 |
| Cu (%) | 0 | 0 | 0 | 0 | 0.085 | 0.085 | 0.085 | 0.085 |
| Melamine(%) | 5.2 | 14.2 | 14.2 | 20 | 5.2 | 14.2 | 20 | 30 |
| MCA (mg/g) | 224 | 359 | 359 | 402 | 210 | 330 | 352 | 407 |

In accordance with the invention, the various embodiments thereof provide catalytically activated carbon media that enhances reduction of MCA, as compared to prior art, to provide drinking water that has improved taste, odor, and lowered amounts of toxic chloramines. Those embodiments of the invention implementing low metal content lower costs in addition to preventing toxic metal leaching into drinking water, while still having enough catalytic activity for chloramines reduction. That is, various embodiments of the invention enable the making of catalytically activated carbon media using low amounts of toxic metals to advantageously result in sorbent media that meets requirements of various regulatory bodies (in terms of extraction and leaching requirements e.g., NSF 61 and NSF 42 extraction standards) across the world including NSF for drinking water.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention. CLAIMS

1. A method of making catalytically active metal-triazine treated carbon particles comprising:
providing an activated carbonaceous product;
soaking said activated carbonaceous product in an oxidizing acid solution to form oxidized activated carbon;
providing one or more metal-triazine complexes in solution;
exposing said oxidized activated carbon to said one or more metal-triazine complexes in solution to form metal-triazine impregnated carbon particles;
heating said metal-triazine impregnated carbon particles in a non-oxidizing atmosphere to render calcined metal-triazine impregnated carbon particles; and
cooling said calcined metal-triazine impregnated carbon particles to form catalytically active metal-triazine treated carbon particles that remove at least chloramines from aqueous solution.

2. The method of claim 1 further including draining and drying said oxidized activated carbon prior to exposure to said one or more metal-triazine complexes in solution.

3. The method of claim 1 wherein said activated carbonaceous product is selected from the group consisting of coconut-shell based activated carbon, coal-based activated carbon, wood-based activated carbon, and combinations thereof.

4. The method of claim 1 wherein said activated carbonaceous product is soaked in an oxidizing acid solution from the group consisting of sulfuric acid, phosphoric acid, nitric acid, hydrochloric acid, and combinations thereof.

5. The method of claim 1 wherein said one or more metal-triazine complexes are formed by mixing one or more transition metal compound in solution with a triazine material.

6. The method of claim 5 wherein said one or more transition metal compound comprises one or more transition metal salts selected from the group consisting of iron salts, manganese salts, copper salts, and combinations thereof.

7. The method of claim 1 wherein the one or more metal-triazine complexes comprises at least a manganese-triazine complex, wherein manganese is present in an amount ranging from about 0.005 wt. % to 2.0 wt. % and triazine is present in an amount ranging from about 0.1 wt. % to 30 wt. %, wherein amounts are based on a total weight of oxidized activated carbon to be treated.

8. The method of claim 7 wherein the one or more metal-triazine complexes further comprises an iron-triazine complex, wherein iron is present in an amount ranging from about 0.001 wt. % to 2.0 wt. % and triazine is present in an amount ranging from about 0.1 wt. % to 30 wt. %, wherein amounts are based on a total weight of oxidized activated carbon to be treated.

9. The method of claim 7 wherein the one or more metal-triazine complexes further comprises a copper-triazine complex, wherein copper is present in an amount ranging from about 0.001 wt. % to 4.0 wt. % and triazine is present in an amount ranging from about 0.1 wt. % to 30 wt. %, wherein amounts are based on a total weight of oxidized activated carbon to be treated.

10. The method of claim 1 wherein the one or more metal-triazine complexes comprises:
a manganese-triazine complex, wherein manganese is present in an amount ranging from about 0.005 wt. % to 2.0 wt. % and triazine is present in an amount ranging from about 0.1 wt. % to 30 wt. %; and
an iron-triazine complex, wherein iron is present in an amount ranging from about 0.001 wt. % to 2.0 wt. % and triazine is present in an amount ranging from about 0.1 wt. % to 30 wt. %; wherein all amounts are based on a total weight of oxidized activated carbon to be treated.

11. The method of claim 1 further including a copper-triazine complex, wherein copper is present in an amount ranging from about 0.001 wt. % to 4.0 wt. % and triazine is present in an amount ranging from about 0.1 wt. % to 30 wt. %, wherein amounts are based on a total weight of oxidized activated carbon to be treated.

12. The method of claim 11 wherein the iron is present in an amount ranging from about 0.02 wt. % to 1.5 wt. % and the copper is present in an amount ranging from about 0.02 wt. % to 2.0 wt. %, wherein amounts are based on a total weight of oxidized activated carbon to be treated.

13. The method of claim 11 wherein the iron is present in an amount ranging from about 0.02 wt. % to 0.8 wt. % and the copper is present in an amount ranging from about 0.02 wt. % to 0.8 wt. %, wherein amounts are based on a total weight of oxidized activated carbon to be treated.

14. The method of claim 1 wherein the one or more metal-triazine complexes comprises:
a manganese-triazine complex, wherein manganese is present in an amount ranging from about 0.02 wt. % to 1.5 wt. % and triazine is present in an amount ranging from about 0.1 wt. % to 30 wt. %;
an iron-triazine complex, wherein iron is present in an amount ranging from about 0.02 wt. % to 1.5 wt. % and triazine is present in an amount ranging from about 0.1 wt. % to 30 wt. %; and
a copper-triazine complex, wherein copper is present in an amount ranging from about 0.02 wt. % to 2.0 wt. % and triazine is present in an amount ranging from about 0.1 wt. % to 30 wt. %,
wherein all amounts are based on a total weight of oxidized activated carbon to be treated.

15. The method of claim 14 wherein the manganese is present in an amount ranging from about 0.02 wt. % to 0.8 wt. %, the iron is present in an amount ranging from about 0.02 wt. % to 0.8 wt. %, and the copper is present in an amount ranging from about 0.02 wt. % to 0.8 wt. %, wherein amounts are based on a total weight of oxidized activated carbon to be treated.

16. Catalytically active metal-triazine treated carbon particles formed by the method of claim 1.

17. A sorbent material formed from a carbonaceous material that is activated to form a catalytically active metal-triazine treated precursor activated carbon, the sorbent material comprising:
from about 0.1 wt. % to about 30 wt. % nitrogen as measured on a total dry precursor weight of oxidized activated carbon to be treated;
from about 0.005 wt. % to 2.0 wt. % manganese as measured on the total dry precursor weight of oxidized activated carbon to be treated;
from about 0.001 wt. % to 2.0 wt. % iron as measured on the total dry precursor weight of oxidized activated carbon to be treated;
wherein the sorbent material provides a chloramine removal amount greater than about 200 mg/g which is calculated by measuring remaining amount of chloramine in water containing known concentration of chloramine that is in contact with 1 g of sorbent material at 20 min.

18. The sorbent material of claim 17 further including from about 0.001 wt. % to 4.0 wt. % copper as measured on a total dry precursor weight of oxidized activated carbon to be treated.

19. The sorbent material of claim 17 wherein the sorbent material comprises about 0.02 wt. % to 1.5 wt. % manganese, about 0.02 wt. % to 1.5 wt. % iron, and further including about 0.02 wt. % to 2.0 wt. % copper, wherein all weight percentages are measured on the total dry precursor weight of oxidized activated carbon to be treated.

20. The sorbent material of claim 19 wherein the sorbent material comprises about 0.02 wt. % to 0.8 wt. % manganese, about 0.02 wt. % to 0.8 wt. % iron, and about 0.02 wt. % to 0.8 wt. % copper, wherein all weight percentages are measured on the total dry precursor weight of oxidized activated carbon to be treated.
